(19) United States
(12) Patent Application Publication
(10) Pub. No.: US 2006/0014726 A1
(43) Pub. Date: Jan. 19, 2006

(54) Derivatives of cyclic1, 3- propanediol phosphate and their action in differentiation therapy

(76) Inventors: Meir Shinitzky, Shmaryahu (IL); Rachel Haimovitz, Rehovot (IL)

Correspondence Address: BROWDY AND NEIMARK, P.L.L.C.;624 NINTH STREET, NW, SUITE 300, WASHINGTON, DC, 20001-5303, US

(21) Appl. No.: 10/507,489

(22) PCT Filed: Mar. 13, 2003
(86) PCT No.: PCT/IL03/00218

§ 371 Date: Aug. 16, 2005

(30) Foreign Application Priority Data
Mar. 13, 2002 (IL) 148668

(51) Int. Cl. A61K 31/663; C07F 9/547

(52) U.S. Cl. 514/109; 554/78; 558/83

(57) ABSTRACT

The present invention discloses new cyclic glycerophosphates and cyclic popandiol phosphates and pharmaceutical compositions comprising said compounds for stimulation of target cells. In particular, enhancing expressions of various proteins within the cell. Such enhancement is used in differentiation therapy.

### FIELD OF THE INVENTION

This invention relates to 1,3-cyclic propandiol phosphate derivatives, pharmaceutical compositions comprising these derivatives and use thereof as cell stimulants.

### PRIOR ART

The following is a list of references which is intended for a better understanding of the background of the present invention.
Boyd, R. K., De Freitas, A. S. W., Hoyle, J., McCulloch, A. W., McInnes, A. G., Rogerson, A. and Walter, J. A., J. Biol. Chem., 262:12406-12408 (1987).
Clarke, N. and Dawson, R. M. C., Biochem. J., 216:867-874 (1976).
Dawson, R. M. C., Ann. Rept. Progr. Chem. 55:365, (1958).
Dawson, R. M. C., Freinkel, N., Jungalwala, F. B. and Clarke, N., Biochem. J., 122:605-607, (1971).
Forrest, H. S. and Todd, A. R., J. Chem. Soc., 1950, 3925, (1950).
Friedman, P., Haimovitz, R., Markman, O., Roberts, M. F. and Shinitzky, M., .J. Biol. Chem., 271:953-957 (1996).
Kennedy and Weiss, J. Biol. Chem., 222:193 (1956).
Kurokawa, H, Lenferink, A E, Simpson, J F, Pisacane, P I, Sliwkowski, M X, Forbes, J T, Arteaga, C L (2000) Cancer Res 60: 5887
Leloir, L. F., Biochem. Biophys., J., 33:186 (1951).
Markham, R. and Smith, J. D., Biochem. J., 52:552-(1952).
Shinitzky, M., Friedman, P. and Haimovitz, R. (1993), J. Biol. Chem., 268:14109-14115.
Shinitzky, M, Haimovitz, R, Nemas, M, Cahana, N, Mamillapalli, R, Seger, R (2000) Eur. J. Biochem. 267: 2547.
Shinitzky, M. WO 00/57,865.
Snedeker, S M, Diaugustine, R P (1996) Prog Clin Biol Res 394: 211.
Su, B., Kappler, F., Szwergold, B. S. and Brown, T. R., Cancer Res., 53:1751-1754, (1993).
Sutherland, J. A., Turner, A. R., Mannoni, P., McGann, L. E. and Turc, J. M. (1986) J. Biol. Response Mod. 5: 250-262.
Ukita, T., Bates, N. A. and Carter, H. E., J. Biol. Chem., 216:867-874, (1955).

### BACKGROUND OF THE INVENTION

L-α-glycerophosphate (αGP), a key constituent in phospholipid metabolism (Kennedy and Weiss, 1956), is abundant in most biological tissues (Dawson, 1958). β-Glycerophosphate (βGP) is a product of enzymatic (Ukita et al., 1955) and alkaline (Clarke and Dawson, 1976) hydrolysis of phospholipids and is formed through the cyclic phosphodiester intermediate 1,2-cyclic glycerophosphate (1,2 cGP) (Ukita et al., 1955; Clarke and Dawson, 1976). 1,2 cGP has been detected in algae species (Boyd et al., 1987) as well as in human cancer tissues (Su et al., 1993). Similarly, αGP can in principle adopt the cyclic form 1,3-cyclic glycerophosphate (1,3 cGP). This compound has been shown to be formed as an intermediate in the phospholipase C hydrolysis of phosphatidyl glycerol (PG) (Shinitzky et al., 1993) and upon further hydrolysis is converted to αGP.

A six-membered cyclic phosphate of foremost biological importance is cyclic AMP. The ring of cyclic AMP is actually a derivative of 1,3 cGP backbone. Other cyclic phosphates which were detected in biological systems include glucose cyclic phosphodiester (Leloir, 1951), 2′,3′-cyclic phosphodiester (Markham and Smith, 1952), riboflavin-4′,5′-cyclic phosphodiester (Forrest and Todd, 1950), myoinositol-1,2-cyclic phosphodieste (Dawson et al., 1971) and cyclic lysophosphatidic acid (Friedman et al., 1996). Synthesis of di- and tri-esters of 1,3-Cyclic phosphates, having biological interest, was disclosed by Penney, C. L. & Belleau, B. in Can. J. Chem. (1978) 56, 2396-2404. Derivatives of 1,3-cyclic phosphates trimesters were used as transition state analogues in the construction of catalytic antibodies (Lavey, B. J. & Janda. K. D. in J. Org. Chem. (1986) 61, 7633-7636 and in Bioorganic & Medi. Chem. Letts. (1996) 6, 1523-24). The crystallographic structures of 5-ethoxytrimethylenephosphoric acid (Gerlt, J. A. et al. J. Org. Chem. (1980) 45, 1282-1286), 1,3,2-Dioxaphosphrinanes (Jones, A. S. et al. J. Org. Chem (1986) 51, 4310-4311) and 5-hydroxy-2-methoxy-1,3,2λ⁵-dioxaphosphacyclohexane-2-oxide (Hamor, T. A. Acta Cryst. (1986) C42, 1462-1463) were reported. The conformational properties of 5-alkoxy and 5-alkyl substituted trimethylene phosphates in solution (Gerlt, J. A. et al. J. Am. Chem. Soc. (1980) 102, 1665-1670) and the thermochemical identification of 3′,5′-cyclic nucleotides, in particular 2-alkoxy derivatives of 1,3-cyclic glycerophosphates (Gerlt, J. A. et al. J. Am. Chem. Soc. (1980) 102, 1655-1660) were reported. Displacement reaction of 1,3cylic glycercphosphates have also been reported (Baran, J. S et al. J. Org. Chem. (1977) 42, 2260-2264). Preparation and chemistry of sn-glycerol-cyclic-phosphodiester isomers (Buchnea D. Lipids (1973) 8, 289-294) and 2,6,7-trioxa-1-phosphabicyclo[2,2,1]heptane (Denney, D. B. & Varga, S. L. Phosphorous (1973) 2, 245-248) were also published.

Except for cyclic AMP and cyclic GMP, which have been extensively studied, no specific biological activities have been so far assigned to the other biological cyclic phosphates.

Breast cancer cells in their virulent undifferentiated state are characterized by lack of functional estrogen and/or progesterone receptors. To date, no method for in situ differentiation of breast cancer cells has yet been proven effective in patients.

Glossary

The following is an explanation of some terms used above and in the following description and claims:

CPP—the 1,3-cyclic propandiol phosphates derivatives used in the present invention.

Target cells—any cells, which have the potential to mature into neural cells. Non-limiting examples of such cells are MCF-7 and T47D human breast cancer cells.

Substantially maintaining—this term relates to the capability of analogs to promote the activity carried out by the cyclic glycerophosphate from which they were derived to a certain extent. The analog's activity will be considered to be substantially maintained wherein the activity is 30% or above, preferably 50% or above, more preferably 70% or above, and most preferably 90% or above the level of the actvity of the cyclic glycerophosphate.

Effective amount—wherein the method of the invention is intended for prevention of a non-desired condition, the term “effective amount” should then be understood as meaning an amount of the active compound which, when administered to an individual, results in the prevention of the appearance of the said condition. Prevention of such a condition, e.g. a neurodegenerative condition, may be required prior to the appearance of any symptoms of a disease, e.g. in individuals having a high disposition of developing the disease, or when the compositions are used for the treatment of nerve rescue which is expected after nerve injury. Wherein the compositions or methods are intended for treatment of an ongoing non-desired condition, the term “effective amount” should then be understood as meaning an amount of the active compound which is effective in ameliorating or preventing the enhancement of the treated condition and related symptoms.

Prevention or treatment—the term prevention of disorders or diseases is to be understood in accordance with the invention as a reduction in the probability of the appearance of such disorders or diseases in an individual having a high predisposition of developing such disorders or diseases, reducing the extent of the symptoms associated with such disorders and diseases when they occur or completely preventing their appearance.

Differentiation therapy—the term is to be understood as inducing tissue specific differentiation for therapeutic means. In accordance with the invention it should be understood as promoting signals responsible for differentiation and maturation leading to inhibiting neoplastic events.

Treatment of such disorders or diseases in accordance with the invention means ameliorating the symptoms associated with the disorders or diseases, reducing the extent of such symptoms or completely eliminating them.

### SUMMARY OF THE INVENTION

In accordance with the invention new derivatives of 1,3-cyclic propandiol phosphate are provided that are capable of stimulating cells.

The present invention thus provides, by a first of its aspects, a compound of formula I 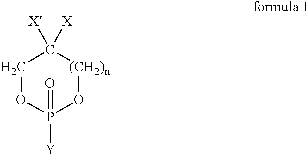
or pharmaceutically acceptable salts thereof, wherein n is 0 or 1; X is hydrogen O—R, NH—R or N—(C═O)—R; X′ hydrogen or CH₂OH; Y is O—R₁, NH—R₁; R is hydrogen, linear or branched alkyl, linear or branched acyl, substituted or non-substituted aryl or araalkyl residue; R₁ is hydrogen, linear or branched alkyl, linear or branched acyl, substituted or non-substiuted aryl, alkylcarboxy ester or alkyl-N—R₂R₃; R₂ and R₃ are independently hydrogen or an alkyl group;

provided that when X and X′ are hydrogen Y is not OR₁ wherein R₁ is hydrogen, alkyl or aryl; that when X′ is hydrogen X is NHR or N(C═O)—R; provided that when X′ is CH₂OH then X is NH—R or NO₂; and that when n=1, X′═H and X═NH(C═O)—CH₃, Y is not O-p-NO₂—C₆H₄.

As used herein the term “alkyl” refers to an alkyl group having from 1 to 24 carbon atom, e.g. preferably from 3 carbon atoms to 20 carbon atoms, most preferably from 5 carbon atoms to 15 carbon atoms; the term “acyl” refers to an aliphatic saturated or unsaturated C₁-C₂₄ acyl group, preferably an acyl group having an even number of carbon atoms, most preferably an acyl group derived from a natural fatty acid such as a saturated aliphatic acyl group selected from acetyl, butyryl, caproyl, octanoyl, decanoyl, lauroyl, myristyl, palmitoyl, and stearoyl, or an unsaturated aliphatic acyl group selected from palmitoleyl, oleyl, linoleyl, and ricinoleyl; and the term “aryl” refers to a mono- or poly-carbocyclic aryl group, most preferably phenyl, optionally substituted by C₁-C₄ alkyl, halogen and/or hydroxy.

In one embodiment, Y is a hydroxyl group; X is O-oleoyl, O-benzyl, O—CH₂COOCH₂CH₃, NH-benzyl or NH-caproyl.

In another embodiment X is hydrogen; Y is O-acetyl or NH—CH₃.

The present invention further provides a pharmaceutical composition comprising a pharmaceutically acceptable carrier and, as an active ingredient, a compound of the general formula (I). A preferred use of said composition is for stimulation of target cells. An activity associated with the use of the CPP of the present invention is promoting cell differentiation and enhancing expression of various proteins within such cells. One particular utilization of such treatment associated by promoting cell differentiation is cancerous cells where promotion of cancerous cells differentiation and promoting protein expression within such cells suppresses their growth, thus effectively fights cancer. In particular, the ability of the pharmaceutical compositions of the invention to promote transcription and expression of estrogen receptor α (ER-α) and progesterone receptor (PR) renders them extremely useful for treatment of various disorders. Thus, the invention also provides a pharmaceutical composition comprising a pharmaceutically acceptable carrier and, as an active ingredient, a compound of the general Formula (I) above, for the prevention or treatment of disorders and diseases which can be prevented or treated by promoting such proliferation of such receptors. Thus overall leading to antitumor activity.

The present invention further provides a method for inducing promotion of transcription and expression of estrogen receptor α (ER-α) and progesterone receptor (PR) comprising contacting said target cells with an effective amount of a compound of the general formula (I) above. Said period of time is such a period, which enables the compositions of the invention to exert their activity. This period of time may easily be determined by a person skilled in the art for each kind of composition and target cells using any of the methods described herewith.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows Western blot analysis of ER-α indicating relative increase in the level of estrogen receptor-α (ER-α) in MCF-7 cells with an increase in 1,3-cPP concentration or incubation time. (A) incubation for 6 days. (C) incubation for 14 days. (B) levels of variant (MW 50,000) after 11 days. (D-F) quantification of the respective bands by densitometry in arbitrary units.

FIG. 2 shows Western blot analysis of ER-α indicating relative increase in the level of ER-α in T47D cells upon incubation with 1,3-cPP. (A) level of wild type ER-α in T47D clone 11 upon incubation with increasing concentration of 1,3-cPP for 6 days. (B) level of ER-α variant (MW 40,000) in T47D clone 8 cells upon incubation with 1,3-cPP for 10 days.

FIG. 3 shows Western blot analysis of PR indicating relative increase in the level of the receptor in MCF-7 cells with an increase in 1,3-cPP concentration or incubation time. Level of wild type (MW 98,000) PR in MCF-7 cells after incubation with increasing concentrations of 1,3-cPP for 8 days and (B) 11 days. (C-D) quantification of the respective bands by densitometry in arbitrary units.

FIG. 4 shows the effect of chronic presence of incubation of 1,3-cPP on the steady state level of ER-α mRNA. MCF-7 cells were incubated with varying concentrations of 1,3-cPP for 6 days (A), 11 days (B) or 14 days (C). T47D clone 8 (ER⁺PR⁺) for 6 days.

FIG. 5 shows the effect of chronic presence of incubation of 1,3-cPP on the steady state level of PR mRNA. MCF-7 (ER⁺PR⁺) cells were incubated with varying concentrations of 1,3-cPP for 8 days (A), 11 days (B).

FIG. 6 shows the effect of 1,3-cPP (50 μM) on the proliferation of T47D human breast cancer cells (clone 11) in vitro.

FIG. 7 1,3-cPP synergizes with sodium butyrate to augment hemoglobin production and inhibit proliferation of K562 cells. Hemoglobin production per 104 cells (A) and total number (B) were determined.

FIG. 8 shows results of an in vivo treatment of mice with 1,3-cPP.

FIG. 9 shows Estrogen receptor alpha level in MCF-7 cells treated with 1,3cPP-d8 (5-Amino-5-hydroxymethyl-2-oxo-2λ5-[1,3,2]dioxaphosphinan-2-ol) for 9 days.

FIG. 10 shows progestrone receptor alpha level in MCF-7 cells treated with 1,3cPP-d8 (5-Amino-5-hydroxymethyl-2-oxo-2λ5-[1,3,2]dioxaphosphinan-2-ol) for 9 days.

FIG. 11 shows Casein Kinase level in MCF-7 cell treated with 1,3cPP-d8 (5-Amino-5-hydroxymethyl-2-oxo-2λ5-[1,3,2]dioxaphosphinan-2-ol) for 9 days.

### DETAILED DESCRIPTION OF THE INVENTION

As mentioned, the present invention provides cyclic glycerophosphates (CGs), and in particular derivatives of 1,3-cyclic propandiol phosphates (CPP). These new derivatives may be used for stimulating cells. In particular, the CPP of the present invention promote differentiation of cells. Such promoting of the enhancement of cell differentiation has therapeutic implications. The resulting induced cell activity may be used in differentiation therapy. Differentiation therapy, in particular with neoplastic events, is associated with the fact that tissue-specific differentiation constitutes a phsiological mechanism that counteracts such events (Snedeker et al. 1996). The CPP of the present invention were indeed found to enhance expression of several proteins associated with differentiation of tumors and better prognosis. In particular, expression of both estrogen receptor 60 (ER-α) and progesterone receptor (PR) correlate with such better prognosis of breast cancer. The CPP analogues of the present invention were found to magnify ER-α and PR transcription demonstrated by Western Blot analysis and expression demonstrated by mRNA. In addition these compounds also demonstrate effective anti-tumor ability against tumors in cancerous breast cells. Acute toxicity testing of the compounds did not show any pharmacotoxic effects in doses as high as 5 g/kg. Naturally occurring CGs in general are formed by enzymatic degradation of phospholipids which in most cases yields five or six membered ring cyclic glycerophosphates. The 1,3-cyclic propandiol phosphates and analogs thereof of the invention may generally be synthesized using any one of the methods known in the art for synthesis of phosphate esters. Specific methods, which may typically be used, for preparing the cyclic phosphates of the invention are described specifically below (see Examples).

In the case of using the new CPP of the present invention for cell differentiation, suitable pharmaceutical compositions comprising as the active ingredient an efficient amount of the CPP are prepared. In addition to the active ingredient, the pharmaceutical compositions may also contain a carrier selected from any one of the carriers known in the art. The nature of the carrier will depend on the intended form of administration and indication for which the composition is used. The compositions may also comprise a number of additional ingredients such as diluents, lubricants, binders, preservatives, etc.

The compositions of the invention may be administered by any suitable way. A preferred mode of their administration is either i.v., topically or per os although at times it may be advantageous to use other administration modes as well.

Typically, the pharmaceutical compositions of the invention will comprise about 1 mg to about 100 mg of the active material per kg body weight of the treated individual.

While the compositions of the invention will typically contain a single CPP, it is possible at times to include in the composition or to co-administer two or more CPP, which may then act together in a synergistic or additive manner to prevent or treat a neoplastic event/disorder.

The CPP used in the invention may be used in any of their isomer forms. For various purposes, one of the isomers may be preferred over the remaining ones. According to the invention, the CPP may be administered either in a single dose or may be given repetitively over a period of time. The compositions of the invention may also be administered to the treated individual in combination with an additional treatment, e.g. wherein the treated condition is neoplastic, the compositions may be given together with one of the currently available drugs or therapies used for treatment of cancer. In such a combination treatment the CPP may be administered simultaneously with or at different times than the administration of the additional treatment so as to yield a maximum preventive or therapeutic effect.

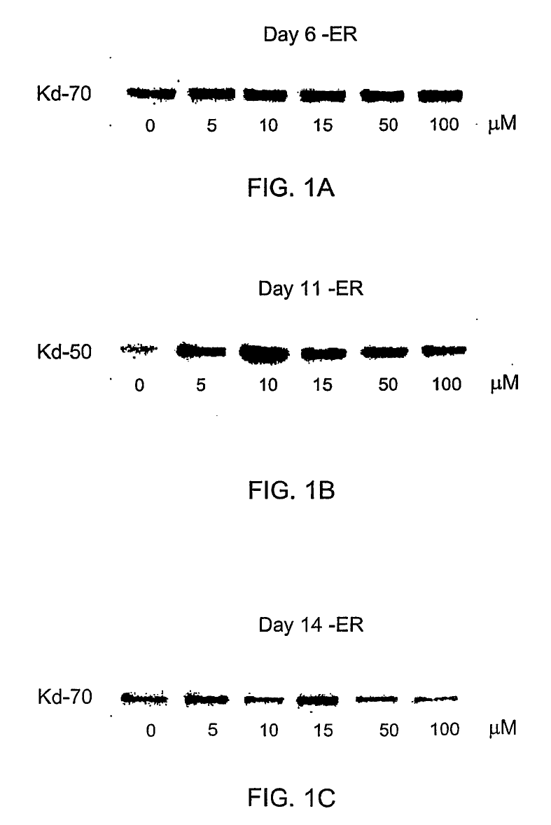

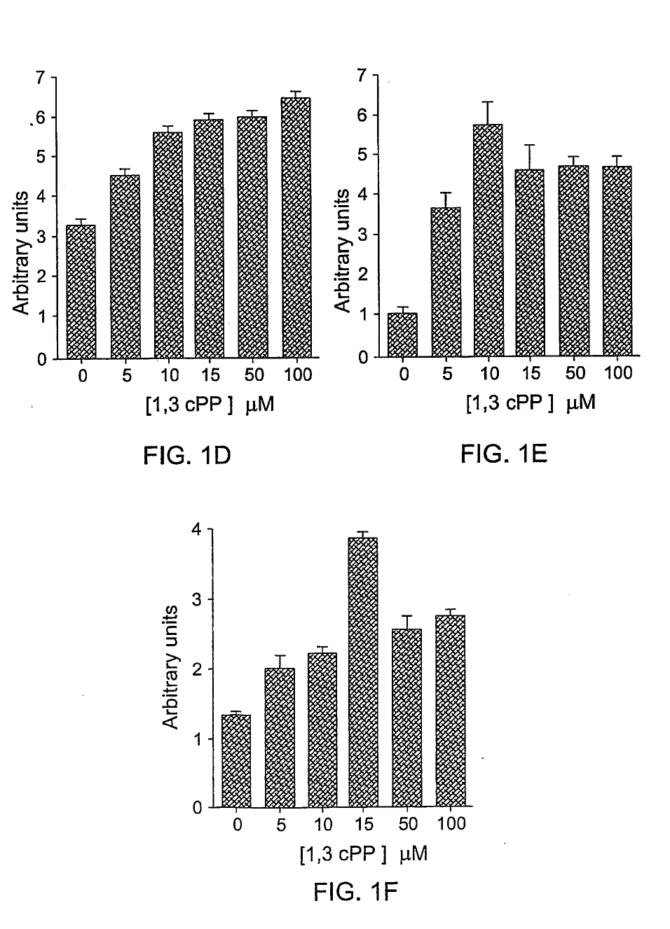

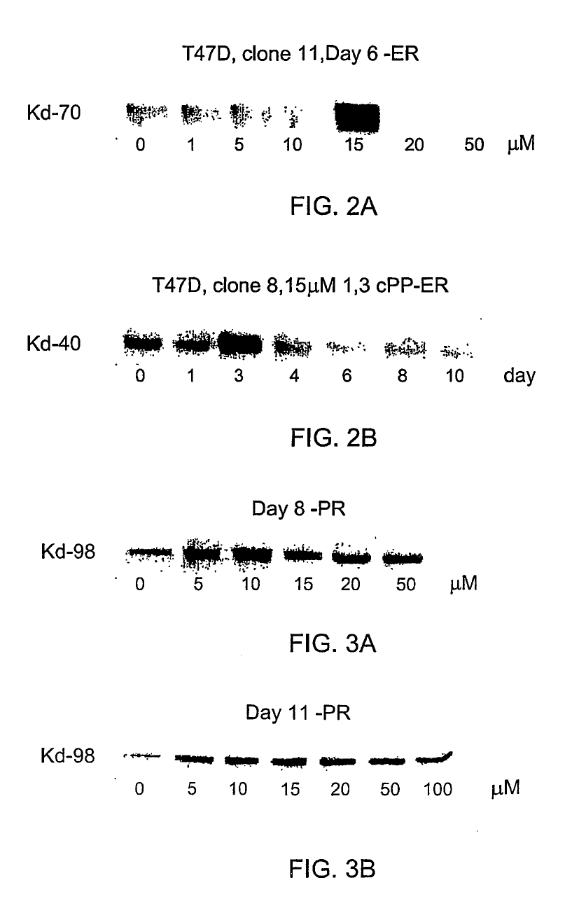

Turning to FIG. 1 there are shown Western blot analyses showing the effect of 1,3cPP on the expression level of ER-α. In the ER-α assay, MCF-7 cells were incubated with 1-100 μM 1,3cPP for up to 14 days. The analysis indicates a relative increase in the level of wild type ER-α receptor (MW 70,000) with either an increase in 1,3cPP concentration or time of incubation. On days 6 and 14, a nearly 2-fold and 3-fold increase were observed, respectively (FIGS. 1A, C, D, F). In addition, an increase in ER-α variants, most notably a 5-fold increase in the intensity of a ER variant with an approximate MW of 50,000 In the Western blot assays for ER-α a receptor variant of MW ˜50,000 (FIGS. 1B,E) was observed on day 11. This band could be related to one of deleted exons D3-4 (MW 49,000), D4 (MW 54,000), or D7 (MW 51,000) ER-α variants. FIG. 2 demonstrates the increase of ER-α in T47D (ER⁺PR⁺) clone 11 cells. Incubation for 6 days in the same concentration range produced a sharp increase of the wild type receptor at 15 μM 1,3-cPP (FIG. 2A). In the T47D clone 8 (ER^{lo} PR^{lo}), after 3 days incubation with 15 μM 1,3-cPP, a sharp increase in the expression of variant ER-α (MW≈40,000) which correspond to the D5-ER (MW 40,000) or D4/7-ER (MW 34,000) variants (FIG. 2B), was observed.

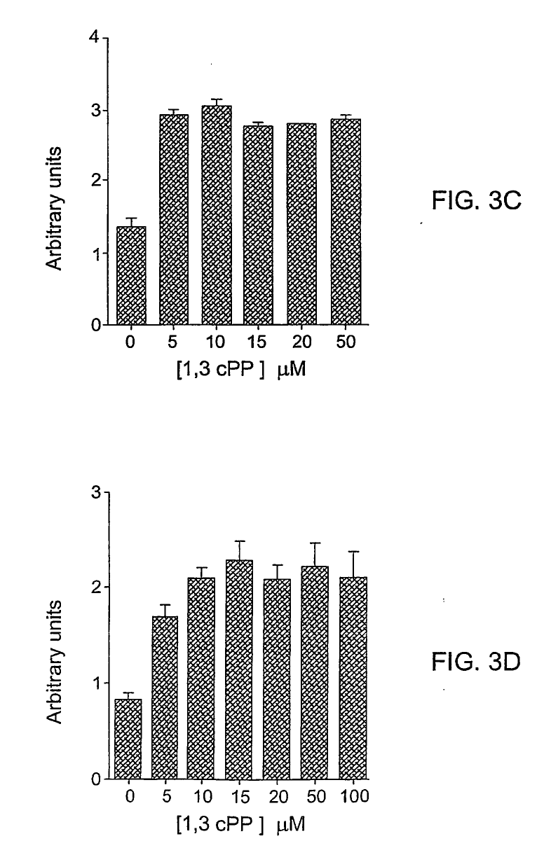

In an analogous manner, a set of experiments was preformed with MCF-7 cells for determining the level of PR upon incubation with varying concentrations of 1,3-cPP for a period of up to 11 days. Similar to the augmentation observed for ER-α, an increase of up to 2.8 and 2.2 fold expression of the wild type PR (MW 98,000), was observed from 10 μM 1,3-cPP and upwards on days 8 and 11, respecively (FIGS. 3A-D).

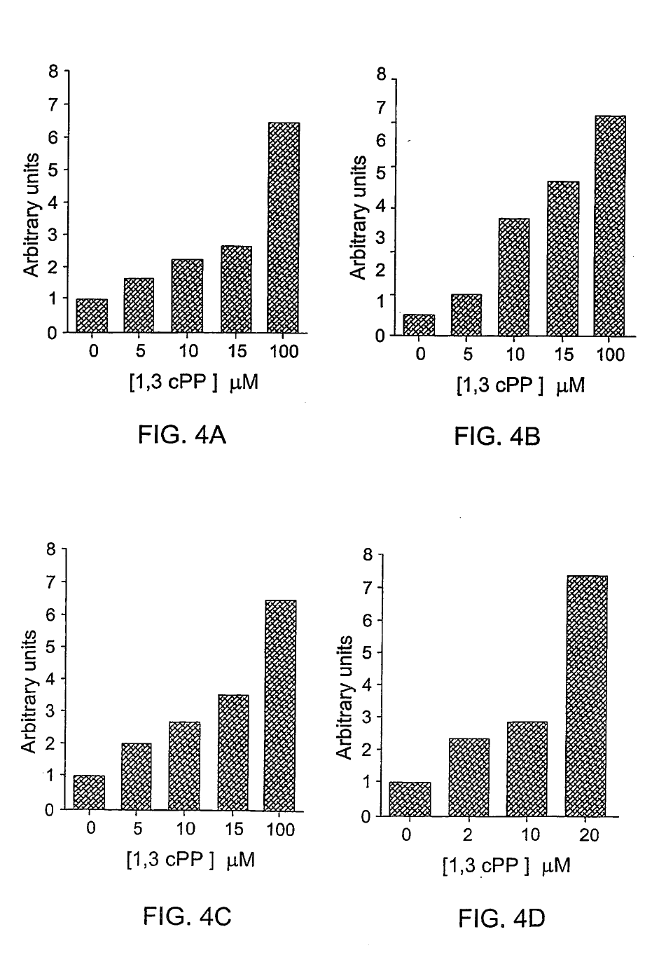

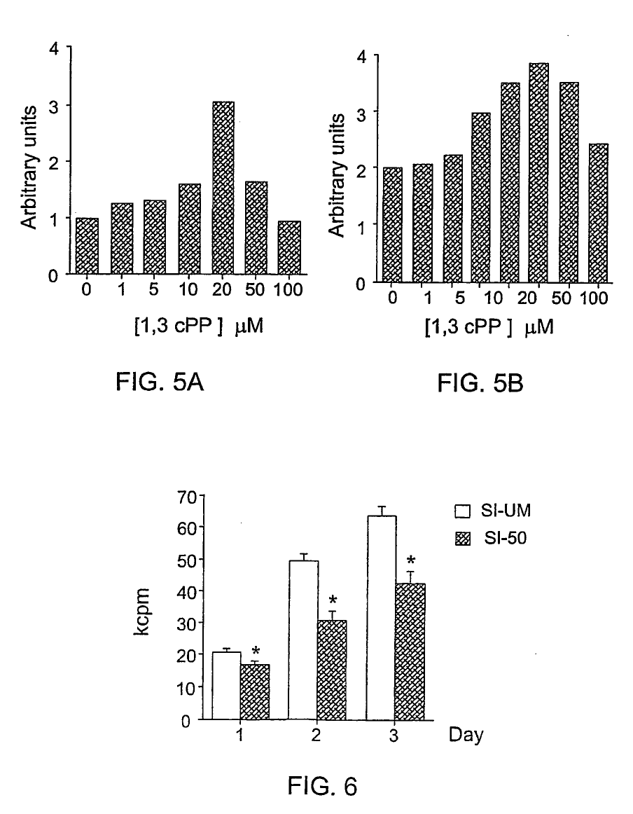

It should however be understood that the augmented expression of ER-α and PR presented in FIGS. 1-3 could have in principle originated from increase in either transcription or translation associated with the respective steroid receptor genes. Therefore the effects of long term incubation with 1,3cPP on the respective ER-α and PR mRNA levels were examined. Quantitative RT-PCR was carried out with a Light Cycler as described. As shown in FIGS. 4A-C, chronic exposure of MCF-7 cells to 100 μM 1,3cPP for a period of up to 14 days, induced a 6 fold increase in the normalized ER-α mRNA transcription on days 6 and 14, whereas a 10-fold increase was observed at 50 μM on the 11^{th} day. In contrast, only 20 μM 1,3-cPP were required to induce 7-fold increase in the ER-α mRNA in T47D clone 8 cells (FIG. 4D). The analogous data for PR are depicted for MCF-7 cells in FIGS. 5A-B where at 20 μM, there was a 3 fold increase in the normalized PR mRNA expression on the 8^{th} day. This increase receded to about 1.5-fold by the 11^{th} day.

The observed parallel increase in ER-α and PR and their mRNA expression upon treatment with 1,3-cPP suggests that there occurs an elevation in the state of differentiation which implies a reduction in the rate of cellular proliferation. In order to validate such an observation, T47D cells were incubated with varying concentration of 1,3-cPP in the range of 1-50 μM in a standard 5 day [3H]thymidine uptake assay. As shown in FIG. 6, 50 μM of 1,3-cPP significantly inhibited proliferation over the course of the first 3 days of incubation compared to control cultures with P values 0f 0.0370, 0.0192 and 0.0238 on days 1-3, respectively. The observed effect was lost after the third day, possibly, due to the fact that 1,3-cPP was consumed by the cells or underwent hydrolysis to its linear form.

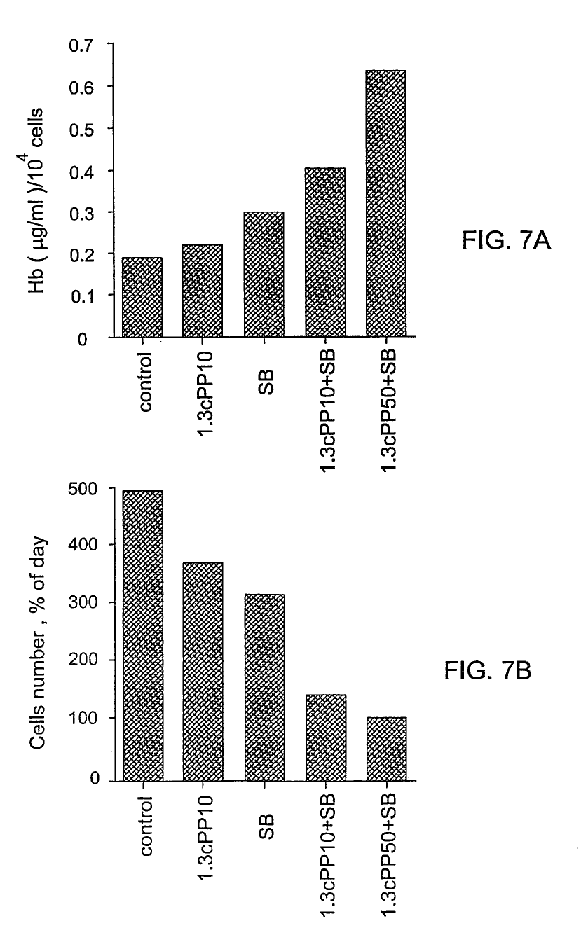

It is known from the literature that sodium butyrate derives K562 cells into the erythroid differentiation program (Sutherland et al. 1986). Base on such an observation, the ability of 1,3-cPP alone or in combination with sodium butyrate may trigger the erythroid differentiation program manifested by hemoglobin production. Turning to FIG. 7A, 1,3-cPP alone has almost no effect. 1 mM sodium butyrate has only a small effect on hemoglobin synthesis on the fifth day of incubation. However, 10 μM 1,3-cPP together with 1 mM sodium butyrate resulted in more than doubling the baseline production of hemoglobin. 50 μM 1,3-cPP together with 1 mM sodium butyrate resulted in more than tripling such production. It should be noted that a concurrent decrease in the total cell number on the fifth day most prominently in the 50 μM 1,3-cPP together with 1 mM sodium butyrate treatment group (FIG. 7B). Cell viability in all groups was over 85%. These results lent further credence to the contention that 1,3-cPP can trigger a defined differentiation program in tumor models.

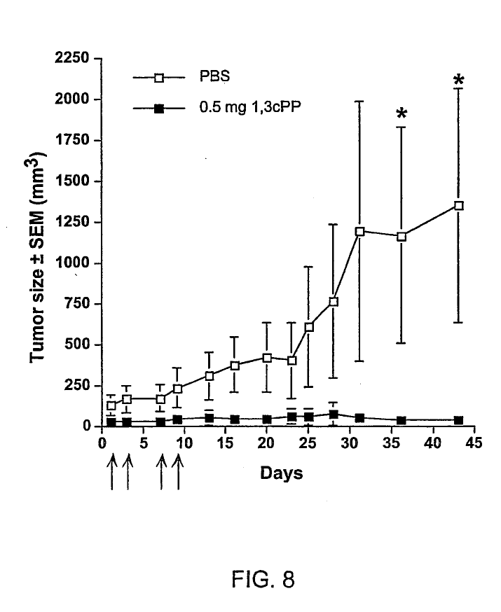

The Western blot and PCR results suggest that 1,3cPP could slow down tumor growth in vivo. To test this possibility, we followed the procedure of Kurokawa et al. Female athymic outbred CD-1 mice were implanted with a slow release estradiol tablet and injected intra-fat-pad (i.f.p.) in the lower right abdomen 3×10⁶ viable MCF-7 cells (see Materials and Methods). Twelve days later, when the tumors became palpable, mice were randomly allocated into two groups, each with six mice. The control group was injected with PBS i.p. and the treatment group was injected with 0.5 mg 1,3cPP dissolved in PBS i.p. in the lower left abdomen on day 1,3,6, and 8. Tumor size was then measured 2-3 times a week. In the control group, the tumors grew continuously and reached an average size of >1250 mm³. The origin of the large variation in tumor size was due to one mouse with a relatively small tumor in this group. In spite of this large SEM, all mice in each group were included in the statistical analysis and as depicted in FIG. 8, a significant difference was observed between the treatment and control groups on day 36 (P=0.032) and day 43 (P=0.032). No observable toxic effects in either group were observed during the course of the experiment.

### EXAMPLES

The invention will now be illustrated by the following non-limiting examples.

Chemical Synthesis

1,3 cyclic propandiol phosphate. This compound (1,3-cPP) was prepared by the procedure described (Shinitzki et al. 2000) and was dissolved in Hanks' balanced salt solution (HBSS) or cell culture medium and sterilized by filtration.

Additional cyclic phosphates of the invention are prepared using various starting materials for forming the 1,3-cyclic propandiol moiety substituted with the appropriate derivatives. The reaction of a suitable β-glyceryl derivative (oleoyl, benzyl) with POCl₃, gives the desired cyclization and yields the oleoyl and benzyl derivatives, respectively of the 1,3-cyclic propandiol ring. Serinol (2-amino-1,3-propandiol) or 1,3-cyclic propandiol phosphatre are also used as starting materials for the synthesis of other derivatives as described below.

The reaction is carried out in an anhydrous solvent, e.g. dioxane or methylene chloride. The synthesis of a series of novel 6-membered ring cyclic phosphates is illustrated below.

General

Free phosphates (either the acid form or the sodium salt) were prepared by the following general procedure involving the preparation of Solutions a-d:

Solution a: 0.1M of the dialcohol dissolved in freshly distilled methylene chloride.

Solution b: 0.1M of freshly distilled phosphorous oxichloride (POCl₃, 15, 35 gr or 9.35,1) dissolved in freshly distilled methylene chloride.

Solution c: Acetone-Water 9:1 (v/v).

Solution d: Acetone-0.1M aqueous sodium bicarbonate.

Procedure: To a cooled (4° C.) solution a, an equi-volume of solution b was added dropwise while stirring. The temperature was then slowly raised to boiling and allowed to reflux for 406 hours. The solvent was evaporated. The residue was dissolved either in solution c (to obtain the free acid) or solution d (to obtain the sodium salt). After 24 hours the solvent was evaporated yielding the desired crude product. Recrystalization was done from either acetone or acetonitirile.

Phosphate esters and phosphateamidates were prepared as mentioned above with the following modification. At the last step, the phosphorous monochloride derivative was further reacted in methylene chloride with an alcohol (e.g. benzyl alcohol) to obtain the respective ester of the cyclic phosphate. Alternatively it may be reacted with a primary or secondary amine and an equivalent of triethylamine to obtain the phosphoamidate of the cyclic phosphate. After evaporation the crude product was recrystallized from a water/ethanol solution.

### Example 1

### Synthesis of 1,3-cyclic propandiol phosphate-5-oleoyl

β-glyceryl mono oleate (Sigma) was reacted with equimolar amount of POCl₃ in freshly distilled dry CH₂Cl₂ under reflux for 8 hours. Hydrolysis of the remaining P—Cl bond was afforded by evaporating the solvent and redissolving the residue in acetone-aqueous sodium bicarbonate 9:1 (v/v). After 24 hour the solvent was evaporated and the product was purified by chromatography on silica gel with mixtures of chloroform-methanol-water as eluants.

### Example 2

### Synthesis of 1,3-cyclic propandiol phosphate-5-benzyloxy

β-benzyl glycerol (Sigma) was reacted with equimolar amount of POCl₃ analogously to Example 1 and purified by thin layer chromatography (TLC) of silica gel.

### Example 3

### Synthesis of 1,3-cyclic propandiol phosphate-5-benzylamino

Serinol (Aldrich) was reacted with benzyl bromide in dry CH₂Cl₂. The product (N-benzyl serinol) was reacted with POCl₃ as in Example 1. Purification was afforded by silica gel chromatography.

### Example 4

### Synthesis of 1,3-cyclic propandiol phosphate-5-caproylamido

Caproic acid (Aldrich) and N-hydroxy succinimide (Aldrich) were reacted with dicyclohexyl carbodiimide (DCC, Aldrich) in ethyl acetate. The formed active ester caproyl hydroxy succinimide was collected in the supernatant. It was further reacted with serinol (Aldrich) in tetrahydrofuran (THF) −0.1 M aqueous sodium bicarbonate 1:1 (V/V). The obtained caproyl amide of serinol was isolated and reacted with POCl₃ as in examle 1. The product was isolated by TLC on silica gel.

### Example 5

### Synthesis of 1,3-cyclic propandiol phosphate-2-benzyloxy

Benzyl dichlorophosphate was prepared by mixing equimolar amounts by benzyl alcohol with POCl₃ for 1 hour at room temperature. Then one equivalent of 1,3 propanediol (Aldrich) in dry CH₂Cl₂ was added and allowed to react by reflux for 18 hours. One volume of aqueous 0.1M NaHCO₃ was then added and mixed. The CH₂Cl₂ layer which contained the product was separated and washed several times with water. The CH₂Cl₂ was evaporated and the product (oil) was collected.

### Example 6

### Synthesis of 1,3-cyclic propandiol phosphate-2-acetyloxy

1,3 Cyclic propanediol phosphate (1,3 cPP (Shinitzky et al. 2000 Eur. J. Biochem. 267:2547) was dissolved in acetic acid and diluted with an excess of acetic anhydride (Aldrich). The mixture was refluxed for 8 hours and then evaporated under vaccum. The product, a mixed anhydride of 1,3 cPP and acetic acid, remained as oil.

### Example 7

### Synthesis of 1,3-cyclic propandiol phosphate-2-methylamino

1,3 Propanediol was reacted with equimolar amounts of POCl₃ for 5 hours in CH₂Cl₂ to yield 1,3 cyclic chloropropanediol (1,3 cPP-Cl, Shinitzky et al., 2000). The solvent was evaporated and the product extracted with ether. 1,3 cPP-Cl was dissolved in tetrahydrofuran (THF) and reacted with methylamine gas for 5 hours. The THF was evaporated, the precipitate collected and the final product crystallized from isopropanol.

The compound was pure on a thin layer chromatography (n-propanol:NH₃:water, 6:3:1, Rf 0.7) and mass spectra analysis gave the predicted molecular weight.

### Example 8

### Synthesis of 1,3-cyclic propandiol phosphate-5-glycine ethylester

1,3 cPP-Cl synthesized as described above was reacted with equimolar amounts of glycine ethylester and triethylamine in THF for 24 hours. The THF was evaporated and the precipitate collected. The final product was extracted with ether.

The compound was pure on a thin layer chromatography (chloroform:methanol:water, 68:25:4, Rf 0.76) and mass spectra analysis gave the predicted molecular weight.

### Example 9

### Synthesis of 1,3-cyclic propanediol phosphate

0.5 M solution of 1,3-propanediol (Aldrich) in freshly distilled methylene chloride was cooled to 40° C. To this solution, an equimolar amount of freshly distilled POCl₃ dissolved in methylene chloride was added dropwise with stirring. The temperature was then raised slowly to boiling and kept under reflux for 6 hours. The solution was then evaporated to complete dryness and acetone-water (9:1) was added. The solution was left at room temperature for 24 hours and then evaporated to dryness to obtain the acid form of the product. Crystallization was afforded from acetone or acetonitrile.

### Example 10

### Synthesis of 2-methyl 1,3-cyclic propanediol phosphate

0.5 M solution of 2-methyl 1,3-propanediol (Aldrich) was reacted with an equimolar amount of POCl₃ as in Example 9.

### Example 11

### Synthesis of 1-methyl 1,3-cyclic propanediol phosphate

0.5 M solution of 1,3-butanediol (Aldrich) was reacted with an equimolar amount of POCl₃ as in Example 9.

### Example 12

### Synthesis of 2-dimethylamine ethyl ester 1,3-cyclic propanediol phosphate

Distilled and dry 2-dimethylamine ethanol (Aldrich) was dissolved in dry methylene chloride. An equimolar amount was added to 1,3-cyclic propanediol phosphate (prepared according to Example 9) in methylene chloride and refluxed for 4 hours. Upon cooling the hydrochloride salt of the product precipitated. The compound was crystallized from ethanol.

### Example 13

### Synthesis of 1,3-cyclic propanediol phosphoamidate

1,3-propanediol was reacted with an equimolar amount of phosphorus oxychloride in methylene choride and the resulting 1,3-cyclic-propanediol phosphate-Cl was reacted with ammonia gas, yielding 1,3-cyclic-propanediol phosphate-NH₂. The compound was pure on thin layer chromatography (n-propanol:NH₃:H₂O 6:3:1 v/v, Rf 0.63).

### Example 14

### Synthesis of 1,3-cyclic propanediol N-ethyl phosphoamidate

1 equivalent of 1,3-cyclic-propanediol-phosphate-Cl as prepared in the preceding example, was reacted with an equivalent of ethylamine in the presence of equivalent of triethylamine in tetrahydrofuran. Final product was pure on TLC (n-propanol:NH₃:H₂O 6:3:1v/v).

### Example 15

### Synthesis of 1,3-cyclic propanediol phosphoamidate glycine ethylester

1 equivalent of 1,3-cyclic-propanediol-phosphate-Cl as prepared in Example 13, was reacted with glycine ethylester hydrochloride in the presence of 2 equivalents of triethylamine. The final product was pure on TLC (chloroform:methanol:water 65:25:4 v/v, Rf 0.76).

### Example 16

### Synthesis of 2-benzyloxy 1,3-chloropropanediol phosphate

2-benzyloxy 1,3 propanediol (Aldrich) was reacted in equimolar amounts with phosphorus oxychloride in methylene chloride. Benzoxy 1,3-cyclic propanediol phosphate was pure on TLC (n-propanol:NH₃:H₂O 6:3:1 v/v, Rf 0.63).

### Example 17

### Synthesis of 2-caproimido 1,3-chloropropanediol phosphate

Caproic acid was reacted overnight with N-hydroxy succinimide (NHS) in the presence of DCC in equimolar amounts. The obtained precipitate, DCU, was separated and discarded, and the caproic acid-NHS ester was extracted from the supernatant. This compound was dissolved in THF and reacted overnight with 1 equivalent of serinol dissolved in 0.1 M NaHCO₃. The solvent was evaporated and the amide of caproic acid-serinol extracted with ethyl acetate and then reacted with phosphorous oxychloride in methylene chloride. The final product was pure on TLC (chloroform:methanol:water 65:25:4 v/v, Rf 0.83).

### Example 18

### 5-Amino-5-hydroxymethyl-2-oxo-2λ5-[1,3,2]dioxaphosphi-nan-2-ol (1,3cPP-d8)

Trihydroxymethylaminomethane was dissolved in water. The aqueous solution was brought to dryness over silica. The adsorbed trihydroxymethylaminomethane was placed in anhydrous CH₂Cl₂ and an equivalent amount of POCl₃ was slowly added (dropewise). The combined solution was stirred in reflux (ca. 40° C.) for several days until HCl fumes were not detected. CH₂Cl₂ was evaporated, water were added, the solution brought to dryness and the product isolated.

### Example 19

### 5-Nitro-5-hydroxymethyl-2-oxo-2λ5-[1,3,2]dioxaphosphi-nan-2-ol

The compound was synthesized in a manner similar to the compound in Example 18, where the starting material was Trihydroxymethylnitromethane.

Biological Activity

Breast Cancer Cells. The human breast cancer MCF-7 cell line were obtained from Prof. Hadassa Degani, of Weizmann Institute of Science, Rehovot, Israel. The cells were grown as monolayers in high glucose DMEM supplemented with 6% fetal calf serum and combined antibiotics. Human breast cancer T47D cells, clones 8 (ER^{lo}PR^{lo}) and 11 (ER⁺PR⁺) were obtained from Prof Iafa Keydar, Tel-Aviv university and were grown in DMEM supplemented with 10% fetakl calf serum antibiotics. K562 erythroleukemia cells were obtained from Dr. Alfa Peled of Weizmann Institute of Science, Rehovot, Israel. These cells were grown in RPMI 1640 containing 10% fetal calf serum and antibiotics. All lines were grown at 37° C. in the presence of 5% CO₂. The absence of Mycoplasma contamination was monitored by a Mycotrim TC test (Irvine Scientific, Santa Ana, Calif.) carried out once every 3 months.

### Example 18

### Western Blot Analysis

For ER-α protein analysis, MCF-7 and T47D cells were cultured in 60×15 mm petri dishes. From the second day of culture onward, the cells were treated with various concentrations of 1,3cPP for up to 14 days. At the end of the incubation period, the medium was aspirated and the cells were washed 3 times with cold (4° C.) PBS. The cells were then gently scraped off using a rubber policeman in 0.25 ml of lysis buffer composed of 50 mM β-glycerophosphate, 1 mM DTT, 1.5 mM EGTA, 1 mM EDTA, 1% (Octylphenoxy)polyethoxyethanol (IGEPAL, Sigma, St. Louis, Mo.), a nonionic detergent, and a cocktail of protease inhibitors, including 1 mM phenylmethylsulfonyl fluoride (PMSF), 1 mM benzamidine, 10 μg/ml aprotinin, 10 μg/ml leupeptin, and 2 μg/ml pepstanin, as well as 1 mM sodium orthovanadate (Sigma, St. Louis, Mo.) as a phosphatase inhibitor. The lysate was then vortexed, centrifuged for 15 min at 10,000×g at 4° C., and the supernatant was collected for analysis. The protein concentration in each sample (1.5-4 mg/ml) was determined using the Coomassie Protein Assay (Pierce, Rockford, Ill.) according to the manufacturer's instructions. Aliquots of 20 μg protein were subjected to SDS/PAGE and then transferred to nitrocellulose membranes for Western blotting. Membranes were stained with 0.1% Ponceau S solution (Sigma, St. Louis, Mo.) and inspected visually to ensure that all lanes were loaded equally. Membranes were washed several times with PBS until the stain was entirely removed. After blocking with a solution of 5% nonfat milk, the blots were incubated individually with polyclonal rabbit-anti-human ER-α and PR antibodies (Santa Cruz Biotechnology Inc., Santa Cruz, Calif.) at 4° C. for 16 hr. Bound antibodies were detected by horseradish peroxidase-conjugated goat anti-rabbit IgG, (Transduction Laboratories, Lexington, Ky. using the ECL detection method. Band densities were quantified by densitometry (Biorad model GS-690 Imaging densitometer) using Molecular Analyst software.

### Example 19

### Reverse Transcription (RT) Reaction

MCF-7 and T47D cells were cultured and treated as described above. Total cellular RNA was extracted with TRI reagent according to the manufacturer's instructions (Molecular Research Center, Inc. Cincinnati, Ohio). Reverse transcription (RT) was performed in a total reaction mixture of 20 μl with 1-5 μg RNA by first heating to 65° C. for 5 min in the presence of 25 μg/ml Oligo (dT)₁₂₋₁₈, and 0.5 mM deoxynucleotide triphosphates (dNTP). The RT reaction mixture was then quickly cooled on ice. After centrilugation, this annealed reaction was diluted into a RT buffer containing final concentrations of 50 mM Tris (pH 8.3), 75 mM KCl, 3 mM MgCl₂ and 10 mM DTT. The RT reaction was incubated at 42° C. for 2 min and 200 units of Superscript II RNase H⁻ Reverse Transcriptase (GibcoBRL Life Technologies, Rockville, Md.), was added. The RT reaction was carried out at 42° C. for 50 min and inactivated at 70° C. for 15 min.

### Example 20

### Quantitative PCR

RT-PCR was carried out on a programmable thermal controller instrument according to standard protocols, where the annealing temperatures were 58° C. for ER-α and 56° C. for PR. The PCR product was identified by ethidium bromide illumination on 1.5% agarose gel and corresponded to the expected length of the flanking oligonucleotides (148 bp for ER-α and 319 bp for PR). The PCR products were diluted and used to build a standard curve for the quantitative PCR which was carried out in a Light Cycler instrument (Roche Diagnostics, Mannheim, Germany). The PCR was performed in glass capillaries, which ensured rapid equilibrium between the air and the reaction components due to the high surface-to-volume ratio of the capillaries. Primers for ER-α were 5′-GCTCTTCCTCCTGTTTTTAT-3′ and 5′-TGTGCAATGACTATGCTTCA-3′ [10]. Primers for PR were 5′-CCATGTGGAGATCCCACAGGAGTT-3′ and 5′-TGGAAATTCAACACTCAGTGCCC-GG-3′ [11]. The primers were synthesized by the Biological Services Unit of our Institute. For amplification detection, the Light Cycler DNA master hybridization probes kit was employed according to the manufacturer's instructions. The PCR mixture contained Taq polymerase, 1× Light Cycler hybridization reaction buffer, a deoxynucleoside triphosphate mixture (with dUTP instead of dTTP) 3.5 mM MgCl₂ and 14 pmol of each primer. Amplification for both genes was performed using the following cycling conditions: denaturation for 15 s at 94° C., followed by 35 PCR cycles which were performed with 3 s denaturation at 94° C., 15 s annealing at 58° C. (for ER-α), 56° C. (for PR), and 30 s extension at 72° C. The PCR run was completed within 45 min. For each control and test sample, the amount of the constitutively expressed house keeping enzyme glyceraldehyde-3-phosphate dehydrogenase (GAPDH) mRNA was quantified by using appropriate primers and the quantity of ER-α and PR mRNA were normalized to the quantity of GAPDH mRNA in each sample. The relative amounts of ER-α and PR mRNA were expressed as normalized 1,3cPP treatment values divided by the normalized control values.

### Example 21

### Proliferation Assay

T47D cells (clone 11;ER⁺PR⁺) were plated in 96 well plates in sets of 6, each containing 8×10⁴ cells in a final volume of 200 μl per well. 1,3-cPP was added to the cultures to form a final concentration of 1-50 μM. Plates were incubated at 37° C. over the course of 5 days, where on each day, one plate was pulsed with [³H]thymidine (5.7 Ci/mmol, Sigma, St. Louis, Mo.) overnight for the last 16 hours of the assay, and then frozen. The plates were harvested (Packard micromate 196 harvester, Merriden, Conn.) and radioactivity was scored on a 96 well plate reader (Packard 96, merriden, Conn.).

### Example 22

### K562 Human Erythroleukemia Differentiation

K562 cells were incubated for 5 days in the presence or absence of 10 or 50 μM 1,3cPP and 1 mM butyric acid as a differentiating agent. Quantitative measurements of hemoglobin production was determined by staining of lysed cells with benzidine-peroxide reagent. The benzidine-peroxide reagent was prepared by dissolving 3,3′,5,5′-tetramethyl benzidine in 90% acetic acid and mixing with an equal volume of freshly prepared 1% hydrogen peroxide. Cell lysate, obtained by hypotonic lysing of 5×10⁴ cells in 0.1 ml distilled water, was added to 0.1 ml benzidine reagent and incubated at room temperature for 10 minutes in the dark. Absorbance was measured at 515 nm and was taken as a relative index of the hemoglobin level.

### Example 23

### Anti-Tumor Assay

Female athymic outbred CD-1 mice 12 weeks of age were obtained from the animal breeding center of our Institute. Animals were maintained and treated according to “Principles of laboratory animal care”, (NIH publication no. 85-23) under the supervision of the Council for Experiments on animals, of our Institute. Mice were anesthetized and implanted subcutaneously with a 0.25 mg, 21-day release 17β-estradiol pellet (Innovative Research of America, Sarasota, Fla.) in the dorsal space and injected intra-fat-pad (i.f.p.) in the lower right abdomen with 3×10⁶ MCF-7 cells. Twelve days later, when the tumors became palpable, mice were randomly allocated into two groups, each with 6 mice. The control group was injected with PBS and the treatment group was injected with 0.5 mg 1,3cPP in PBS i.p. in the lower left abdomen on day 1,3,6, and 8. Tumor diameters were serially measured with calipers assuming a hemiellipsoid shape, where volume=(4π/3)×(length/2)×(width/2)×(thickness/2). There were no changes in appearance, body weight or behavior upon injection of 1,3cPP over the course of the experiment.

### Example 24

### Acute Toxicity Testing

The acute toxicity of 1,3cPP was determined in CD-1 male and female mice, 8-12 weeks of age, via i.v., i.p. and p.o. routes of administration. In an acute 24 hr animal toxicity test of 1,3cPP via i.p. administration in doses of 0.25-5.0 g/kg, no pharmacotoxic effects were observed. Moreover, i.v. administration of up to 1 g/kg and p.o. administration of up to 10 g/kg produced no changes in body weight nor in behavior. Following conventional criteria, at this stage, 1,3cPP may be classified as a practically non-toxic substance.

Biological Activity of the Tested Compounds

1,3-cyclic propanediol phosphate, 2-methyl 1,3-cyclic propanediol phosphate and 1-methyl 1,3-cyclic propanediol phosphate (Examples 9-11 above) exhibited similar activity in promotion of synthesis of estrogen and progesterone receptors in MCF-7 human breast cancer cells. Differentiation of human breast cancer cells was tested in vitro on MCF-7 cells. The results indicated that these compounds have a similar potency for promotion of synthesis of both the estrogen and progesterone receptors.

2-benzyloxy 1,3-chloropropanediol phosphate (Example 16 above) was tested and the results indicated that these compounds have a similar potency to that of 1,3 CPP for promotion of synthesis of both the estrogen and progesterone receptors. Differentiation of human breast cancer cells was tested in vitro on MCF-7 cells in comparison to 1,3 CPP.

2-caproimido 1,3-chloropropanediol phosphate (Example 17 above) was tested and the results indicated that these compounds have a similar potency to that of 1,3 CPP for promotion of synthesis of both the estrogen and progesterone receptors. Differentiation of human breast cancer cells was tested in vitro on MCF-7 cells in comparison to 1,3 CPP.

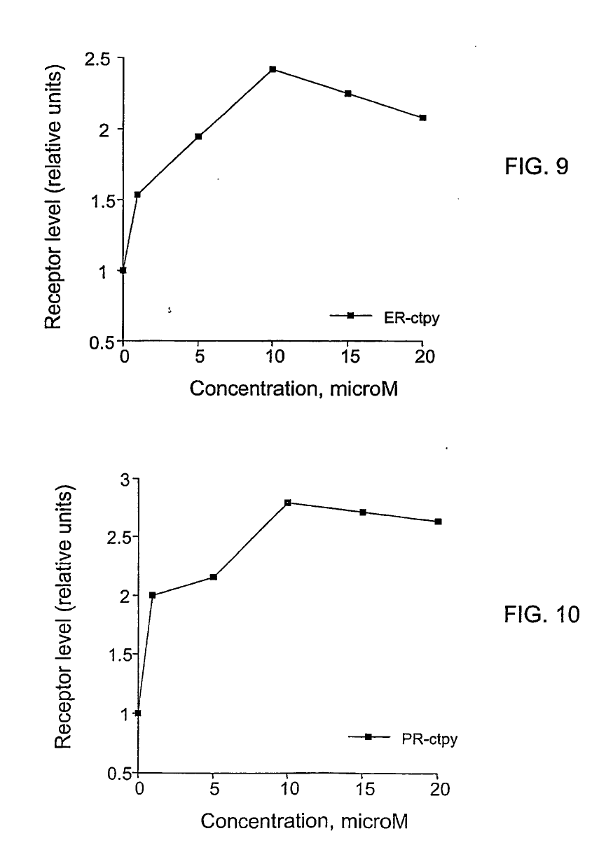

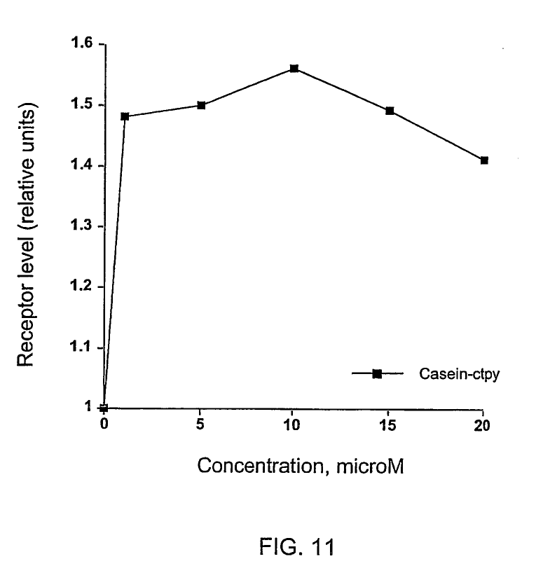

5-Amino-5-hydroxymethyl-2-oxo-2λ5-[1,3,2]dioxaphosphi-nan-2-ol (Example 18 above) exhibited the promotion of synthesis of Estrogen, Progestron receptors and promotion of Casein Kinase levels in MCF-7 cells as shown in FIGS. 9-11.

1-14. (canceled)

15. A compound of the following formula I: 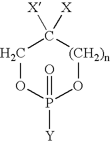
or a pharmaceutically acceptable salt thereof, wherein:
n is 0 or 1;
X is hydrogen, O—R, NH—R or N—(C═O)—R;
X′ is hydrogen or CH₂OH;
Y is O—R₁, NH—R₁;
R is hydrogen, linear or branched alkyl, linear or branched acyl, substituted or non-substituted aryl or aralkyl residue;
R₁ is hydrogen, linear or branched alkyl, linear or branched acyl, substituted or non-substiuted aryl, alkylcarboxy ester or alkyl-N—R₂R₃;
R₂ and R₃ are independently hydrogen or an alkyl group;
alkyl is an alkyl group having from 1 to 24 carbon atoms, preferably from 3 carbon atoms to 20 carbon atoms, most preferably from 5 carbon atoms to 15 carbon atoms;
acyl is an aliphatic saturated or unsaturated C₁-C₂₄ acyl group, preferably an acyl group having an even number of carbon atoms, and most preferably an acyl group derived from a natural fatty acid such as a saturated aliphatic acyl group or an unsaturated aliphatic acyl group; and
aryl is a to a mono- or poly-carbocyclic aryl group, most preferably phenyl, optionally substituted by C₁-C₄ alkyl, halogen and/or hydroxy;
provided that when X and X′ are hydrogen, then Y is not OR₁ wherein R₁ is hydrogen, alkyl or aryl; that when X′ is hydrogen, then X is NHR or N(C═O)—R; that when X′ is CH₂OH, then X is NH—R or NO₂; and that when n=1, X′═H and X═NH(C═O)—CH₃, then Y is not O-p-NO₂—C₆H₄.

16. A compound according to claim 15, wherein the acyl moiety is selected from the group comprising of acetyl, butyryl, caproyl, octanoyl, decanoyl, lauroyl, myristyl, palmitoyl and stearoyl, palmitoleyl, oleyl, linoleyl, and ricinoleyl.

17. A compound according to claim 15 wherein Y is OH and X is O—R or NH—R; wherein R is a linear or branched alkyl or linear or branched acyl.

18. A compound according to claim 15 wherein X is hydrogen and Y is O-acyl or NH—R₁; wherein R₁ is a linear or branched alkyl or linear or branched acyl.

19. Compounds of formula I according to claim 15 selected from the group consisting of:
(a) 1,3-cyclic propandiol phosphate-5-oleoyl;
(b) 1,3-cyclic propandiol phosphate-5-benzyloxy;
(c) 1,3-cyclic propandiol phosphate-5-benzylamino;
(d) 1,3-cyclic propandiol phosphate-5-caproylamido;
(e) 1,3-cyclic propandiol phosphate-2-benzyloxy;
(f) 1,3-cyclic propandiol phosphate-2-acetyloxy;
(g) 1,3-cyclic propandiol phosphate-2-methylamino;
(h) 1,3-cyclic propandiol phosphate-5-glycine ethylester;
(i) 2-methyl 1,3-cyclic propanediol phosphate;
(I) 2-dimethylamine ethyl ester 1,3-cyclic propanediol phosphate;
(k) 1,3-cyclic propanediol phosphoamidate;
(l) 1,3-cyclic propanediol N-ethyl phosphoamidate;
(m) 1,3-cyclic propanediol phosphoamidate glycine ethylester;
(n) 2-benzyloxy 1,3-cyclicpropanediol phosphate;
(o) 2-caproimido 1,3-cyclicpropanediol phosphate;
(p) 5-amino-5-hydroxymethyl-2-oxo-2λ5-[1,3,2]dioxaphosphinan-2-ol; and
(q) 5-nitro-5-hydroxymethyl-2-oxo-2λ5-[1,3,2]dioxaphosphinan-2-ol;
or a pharmaceutically acceptable salt thereof.

20. A pharmaceutical composition comprising a pharmaceutical acceptable carrier and, as an active ingredient, in accordance with claim 15.

21. A pharmaceutical composition according to claim 20, for promoting cell differentiation in cancerous cells.

22. A pharmaceutical composition according to claim 20, for promoting protein expression in cancerous cells.

23. A pharmaceutical composition according to claim 22, wherein said protein is estrogen receptor-α or progesterone receptor.

24. A pharmaceutical composition according to claim 20 wherein the compound of formula I is selected from the group consisting of
(a) 1,3-cyclic propandiol phosphate-5-oleoyl;
(b) 1,3-cyclic propandiol phosphate-5-benzyloxy;
(c) 1,3-cyclic propandiol phosphate-5-benzylamino;
(d) 1,3-cyclic propandiol phosphate-5-caproylamido;
(e) 1,3-cyclic propandiol phosphate-2-benzyloxy;
(f) 1,3-cyclic propandiol phosphate-2-acetyloxy;
(g) 1,3-cyclic propandiol phosphate-2-methylamino;
(h) 1,3-cyclic propandiol phosphate-5-glycine ethylester;
(i) 2-methyl 1,3-cyclic propanediol phosphate;
(j) 2-dimethylamine ethyl ester 1,3-cyclic propanediol phosphate;
(k) 1,3-cyclic propanediol phosphoamidate;
(l) 1,3-cyclic propanediol N-ethyl phosphoamidate;
(m) 1,3-cyclic propanediol phosphoamidate glycine ethylester;
(n) 2-benzyloxy 1,3-cyclicpropanediol phosphate;
(o) 2-caproimido 1,3-cyclicpropanediol phosphate;
(p) 5-amino-5-hydroxymethyl-2-oxo-2λ5-[1,3,2]dioxaphosphinan-2-ol; and
(q) 5-nitro-5-hydroxymethyl-2-oxo-2λ5-[1,3,2]dioxaphosphinan-2-ol;
or a pharmaceutically acceptable salt thereof.

25. A method of treating disorders and diseases which can be treated by promoting cell differentiation comprising administering to an individual in need a therapeutically effective amount of a compound in accordance with claim 15.

26. A method according to claim 25, wherein said disorder is tumor growth.

27. A method of treating disorders and diseases which can be treated by promoting protein expression comprising administering to an individual in need a therapeutically effective amount of a compound in accordance with claim 15.

28. A method according to claim 27, wherein said protein is estrogen receptor-α or progesterone receptor.
